(19) United States
(12) Patent Application Publication
(10) Pub. No.: US 2006/0152671 A1
(43) Pub. Date: Jul. 13, 2006

(54) Object retention device for use with headwear

(76) Inventors: Mark Steven Risso, Sacramento, CA (US); Glen Louis Gross, Fair Oaks, CA (US)

Correspondence Address: GROSS & ASSOCIATES, 8541 DOMINIQUE COURT, FAIR OAKS, CA, 95628, US

(21) Appl. No.: 11/330,655

(22) Filed: Jan. 11, 2006

Related U.S. Application Data
(60) Provisional application No. 60/642,777, filed on Jan. 11, 2005.

(51) Int. Cl. G02C 3/00

(52) U.S. Cl. 351/155

(57) ABSTRACT

A retention device for securing an object, which includes a ferrous portion, to a headwear comprising a first member having a cavity and disposed on the headwear. A channel is formed between the first member and the headwear, wherein the channel has an opening and the channel is operably configured to receive the ferrous portion of the object. A magnetic member is disposed within the cavity and operably configured to magnetically engage the object. Further, the present invention provides a retention device for securing an object to a headwear that also includes a second member having a ferrous portion wherein the second member is removably attached to the object and, is magnetically engageable with the magnetic member in the first member.

### CROSS REFERENCE TO RELATED APPLICATION

This application is a nonprovisional application of U.S. Application No.: 60/642,777, filed on Jan. 11, 2005, which is incorporated, in its entirety, herein by reference.

### BACKGROUND OF THE INVENTION

1. Field of Invention

The present invention is related to the field of retaining eyewear and other ferrous objects to headwear.

2. Description of Related Art

Many people wear some sort of eyewear in the normal course of their daily activities. The reasons for wearing the eyewear vary, but primarily the eyewear is to correct a vision deficiency, reduce the effects of the sun or a combination of the two. Many times a person who wears eyewear (eyeglasses or sunglasses) will temporarily remove the eyewear for various reasons. Once removed, eyewear users look for a place to put the eyewear during the temporary removal. Many users have formed the habit of placing the removed eyewear on their heads. For those eyewear wearers who have this habit of placing their spectacles on their heads, an issue arises when that person is wearing a hat.

When the wearer places the eyewear on the hat, the issue of retaining the eyewear in place is of concern, especially when the user is conducting vigorous activities such as walking, running, hiking, boating bicycling, baseball, softball, playing golf or labor. The eyewear can easily fall, wherein the eyewear could be scratched, stepped on or run over, thereby causing permanent damage to the eyewear.

Some users simply hook the temple of the eyewear on their shirt collar or in a shirt breast pocket. Neither of these two scenarios provides adequate temporary storage while the user is engaged in an activity or even a simple act such as bending over.

Many conventional devices exist to aid and alleviate this problem. Some eyewear users will affix a strap to the eyewear temples to hold the eyewear around the neck and hanging in front of the user's chest. However, as the user moves, the eyewear bounces on the chest, thus becoming a distraction.

Other conventional devices have headwear (commonly referred to as hat or ball caps) with modifications to allow the temples of the eyewear to be inserted into slots or sleeves in order to hold the eyewear on the top of the hat. These conventional hat modifications may be more convenient than the strap retention devices, but they lack in the assurance of the eyewear staying put on the hat. The eyewear temples eventually work themselves out from the user's activity or the eyewear simply falls out of the sleeves if the user bends over or makes a violent or sudden move with their head.

Conventional retaining devices lack the ability to reassure the user that their eyewear will stay on the headwear and not end up on the ground while the user is involved in a vigorous activity. Many conventional eyewear devices, especially sport style sunglasses have straight temples and are constructed of hard plastic for increased durability. Conventional eyewear retaining systems are inadequate for securing such eyewear.

Further, during certain activities, the user may have other articles of various sizes that need a location, wherein the article can be quickly and convenient located. Some articles in particular, for example, golf ball markers or divot repair tools. Many conventional devices have been constructed to retain such articles on hats. However, conventional retaining devices lack the ability to hold both eyewear and article with the same device.

As will be seen from the description below the present invention overcomes the noted deficiencies, as well as others.

### SUMMARY OF THE INVENTION

It is an object of the present invention to overcome the drawbacks and shortcomings of conventional eyewear and article retaining devices. This present invention provides the capability to securely store eyewear on a hat.

Further, the present invention, using the same device, stores articles such as metallic golf ball marker, divot repair tools or other similar ferrous metal objects on the hat.

Additionally, the present invention is not limited to the retention of eyewear on hats. The device may be incorporated into other articles of clothing such as shirt pockets, backpack shoulder straps, for example, enabling the user to have a secure place to store eyewear.

Still further, the present invention enables the user to retain more than just eyewear. Other objects such as a pencil, a pen or a thin flashlight, for example, may be retained by the present invention.

This invention overcomes the drawbacks and shortcomings of the prior art conventional devices and systems.

The present invention comprises a headwear object retaining system for securing an object, which includes a ferrous portion, comprising a headwear, a member having a cavity and is disposed on the headwear such that a channel is formed between the member and the headwear, wherein the channel has an opening and the channel is operably configured to receive the ferrous portion of the object through the opening, and a magnetic member being disposed within the cavity and operably configured to magnetically engage the ferrous portion of the object.

Additionally the present invention is a retention device for securing an object, which includes a ferrous portion, to a headwear comprising a first member having a cavity and is disposed on the headwear such that a channel is formed between the first member and the headwear, wherein the channel has an opening and the channel is operably configured to receive the ferrous portion of the object through the opening, and a magnetic member is disposed within the cavity and operably configured to magnetically engage the ferrous portion of the object.

Further, the present invention provides a retention device for securing an object to a headwear, which includes a first member having a cavity and is disposed on the headwear such that a channel is formed between the first member and the headwear, wherein the channel has an opening and the channel is operably configured to receive the ferrous portion of the object through the opening, a second member having a ferrous portion wherein the second member is removably attached to the object, and a magnetic member is disposed within the cavity and operably configured to magnetically engage the ferrous portion of the second member.

Still further, the present invention describes a retention device for securing an object, which includes a ferrous portion, to an article of clothing comprising a member having a cavity and is disposed on the article of clothing such that a channel is formed between the member and the article of clothing, wherein the channel has an opening and the channel is operably configured to receive the ferrous portion of the object through the opening, and a magnetic member being disposed within the cavity and operably configured to magnetically engage the ferrous portion of the object.

Moreover, the present invention presents in detail a headwear eyewear retaining system for securing eyewear having two temples with ferrous portions comprising a headwear having two opposing side portions, and front and back portions, two first members each having a cavity and one of the members being disposed on one of the side portions of the headwear and the other of the first members being disposed on the opposing side portion of the headwear, each of the first members being disposed on the headwear such that a channel is formed between each of the first members and the headwear, wherein each of the channels has an opening and each of the channels is operably configured to receive a portion of one of the temples of the eyewear through the opening, and a magnetic member being disposed within each of the cavities of the first members and operably configured to magnetically engage the ferrous portions of the temples.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiments of this invention will be described in detail, with reference to the following figures, wherein;

FIG. 1 is a front perspective view of an eyewear retaining device disposed on the exterior of a headwear according to this invention;

FIG. 2 is a rear perspective view of an eyewear retaining device disposed on the exterior of a headwear according to this invention with the eyewear inserted from the rear;

FIG. 3 is a cross-sectional view of the eyewear retention device of FIG. 1 along line 3-3 in FIG. 1;

FIG. 4 is a perspective view of the device made in according to this invention on an alternate form of headwear;

FIG. 5 is a perspective view an optional attachment embodiment of the device made in according to the present invention;

FIG. 6 is a perspective view of still another alternative embodiment of the optional attachment of FIG. 4 made in according to the present invention;

FIG. 7 is a front perspective view the eyewear retention device disposed on the interior of a headwear, wherein the device is made in according to the present invention;

FIG. 8 is a rear perspective view of an eyewear retaining device disposed on the interior of a headwear according to this invention with the eyewear inserted from the rear;

FIG. 9 is a perspective view of the device made in accordance with the present invention retaining objects other than eyewear; and,

FIG. 10 is an perspective view of alternate embodiment of the device made in accordance with the present invention.

### DETAILED DESCRIPTION OF THE PREFERRED EMBODIMENTS

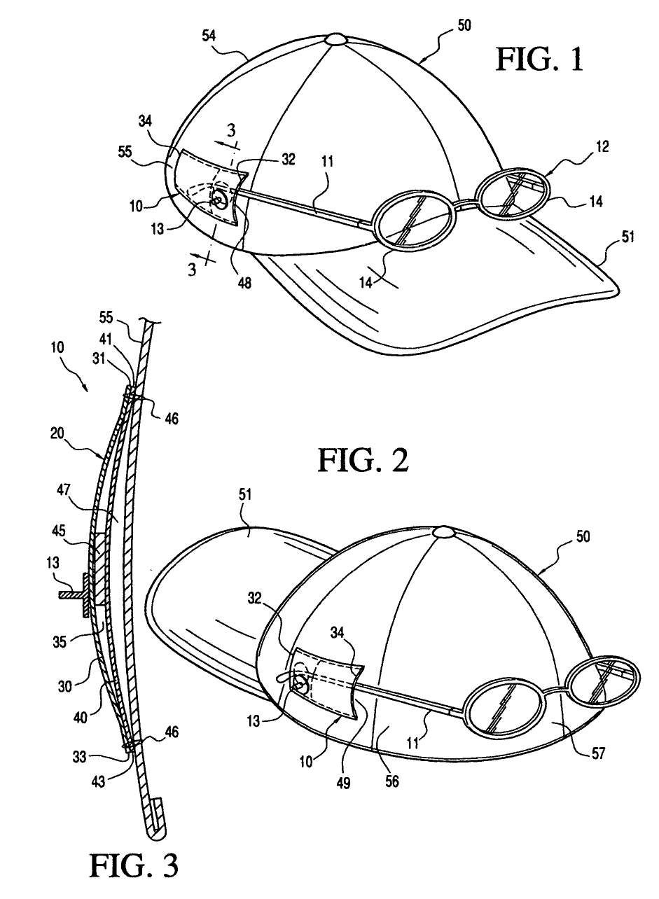

FIGS. 1 and 2 are perspective views of an object retention device 10 for use with headwear made in accordance with this invention. The device 10, as shown in FIG. 1, is disposed on an article of headwear 50 retaining eyewear 12. FIG. 2 is a perspective view of the same embodiment of the device 10, however in this figure the eyewear 12 is in a second or reverse position. Particularly, the eyewear 12 is inserted into the device 10 from the rear of the headwear 50. The device 10 is operably configured to retain eyewear 12 and a plurality of other articles such as, but not limited to ball markers 13 on the headwear 50.

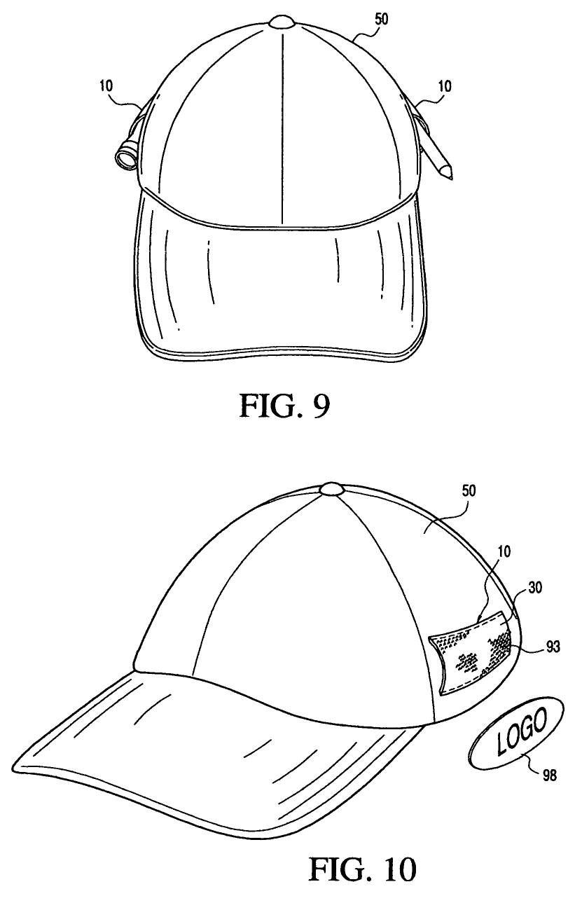

Further, it is contemplated by this invention that the device 10 is designed to retain other objects besides eyewear. For example, the device 10 can retain objects such as, but not limited to, pencils, artist paint brushes, thin flashlights, etc., anything that is made of a ferrous material and the user desires to hold in place on the headwear 50. FIG. 9 is an example of an exemplary embodiment, wherein the device 10 is retaining objects other than eyewear. In FIG. 9, a flashlight and a pencil are inserted into and retained by the device 10.

Referring to FIGS. 1 and 2, the headwear 50 includes a visor or front 51 and a first side 55, a second side 56 and a rear 57. In this embodiment the headwear 50 is a baseball cap style of headwear. It should be appreciated that in other various exemplary embodiments other styles of headwear may be used, such as, but not limited to, sun visors or other headwear typically worn by a user.

The eyewear retention device 10, as shown in FIG. 3, is of a sleeve type design comprising a member 20 and a retaining member 45. The member 20 has first and second side portions 30 and 40. The first and second side portions 30 and 40 have a generally rectangular shape, and are generally flexible. It should be appreciated that in other various exemplary embodiments, the first and second side portions may have other shapes such as, but not limited to square, circular or oval. The member 20 is constructed out of the same material as the headwear. However, it should be appreciated that in other various exemplary embodiments, the device could be constructed out of material different than the headwear; for example, if the headwear is constructed out of leather, the device could be constructed out of leather, canvas, or other material common in the art of making headwear.

Referring to FIGS. 1 through 3, the first side portion 30 includes a first second, third and fourth edge, 31, 32, 33 and 34 respectively, wherein the first and third edges 31 and 33 are opposite of each other, and the second and fourth edges 32 and 34, are opposite of each other. Likewise, the second side portion 40 includes a first and third edge 41 and 43 and a second and fourth edge (not shown), wherein the first and third edges 41 and 43 are opposite of each other, and the second and fourth edges are opposite of each other.

The first side portion 30 is disposed on the second side portion 40 such that the first edge 31 and the first edge 41 align and second edge 32 and second edge of side portion 40 align. In the preferred embodiment the first side portion 30 is sewn to the second side portion 40 along all the edges forming a cavity 35 between the first and second side portions 30 and 40. It should be appreciated that in other various exemplary embodiments, the first and second side portions could be one integral piece of material sewn together along one edge. Further it should be appreciated that in other various exemplary embodiments, the first and second side portions could be fastened together by other means common in the art such as, but not limited to, glue, hook and loop fasteners, etc.

The cavity or pocket 35 provides an enclosure for the retaining member 45, wherein the retaining member 45 is magnetic and is disposed in the pocket 35, as shown in FIG. 3. It should be appreciated that in other various exemplary examples, the retaining member could be of other types such as, but not limited to hook and loop fasteners. The retaining member 45 is generally of a rectangular shape and is smaller in size then the first and the second side portions 30 and 40. The retaining member 45 is inserted in the pocket 35, between the first and second side portions 30 and 40 before the edges are secured together. It should be appreciated that in other various exemplary embodiments, the retaining member could be other shapes such as, but not limited to, ovals, circles, etc., as is common in the art.

The retaining member 45 is disposed in the pocket 35 to aid in the retention of the eyewear 12 and other ferrous articles such as the ball marker 13. In the preferred embodiment, the retaining member 45 is a neodymium magnetic wafer. It should be appreciated that in other various exemplary embodiments, the retaining member could be of various combinations such as, but not limited to, two pieces of magnetic material at both ends of the pocket or a multiple of magnetic wafers positioned within the pocket, as is common in the art. Further, it should be appreciated that in other various exemplary embodiments, a strip of magnetic material equal to the length of cavity could be used providing magnetic retention capability along the length of the cavity.

In the preferred embodiment, shown in FIGS. 1 through 3, when in use, one device 10 is preferably disposed on the side 55 and a second device 10 is preferably disposed on side 56 of the headwear 50, such that the two devices 10 are positioned near the user's temples. The device 10 is sewn to the headwear 50 by use of stitching 46. The stitching 46 is applied to the first edges 31 and 41 and the third edges 33 and 43 of the first and second side portions 30 and 40, wherein a channel 47 is formed between the device 10 and the headwear 50. It should be appreciated that in other various exemplary embodiments, the device could be fastened to the headwear by other means common in the art such as, but not limited to, hook and loop fastener snaps or fabric glue, for example.

The channel 47 has a first entrance 48 and a second entrance 49. The first entrance 48 is disposed on the headwear 50 such that the first entrance 48 is oriented towards the front 51 of the headwear 50. The second entrance 49 is disposed on the headwear such that the second entrance 49 is oriented towards the back 57 of the headwear 50. It should be appreciated that in other various exemplary embodiments, the device could be attached to the headwear with a variation of orientations.

The eyewear 12 includes temples 11 and lenses 14. The eyewear 12 in the preferred embodiment is a pair of sunglasses. However, it should be appreciated that in other various exemplary embodiments, the eyewear could be other types of eyewear such as, but not limited to, safety eyeglasses, prescription eyeglasses, sunglasses or reading glasses.

To retain the eyewear 12 on the headwear 50, the user inserts the temples 11 of the eyewear 12 into the first entrance 48 and into the channel 47 of the device 10 when inserting from the front 51 of the headwear 50. If the user desires to retain the eyewear from the back 57 of the headwear 50, then the temples 11 are inserted into the second entrance 49 and into the channel 47. When the temples 11 are inserted into the device 10, the retaining member 45 retains the temples in place through the magnetic attraction between the retaining member 45 and the temples 11.

The retaining member 45 of the device 10 further provides a means for retaining other ferrous objects. As shown in FIG. 3, a golf ball marker 13 is held in place by the retaining member 45 on the first side portion 30 of the device 10. It should be appreciated that in other various exemplary embodiments other ferrous objects, such as, but not limited to, divot repair tools may be held in place by the retaining member.

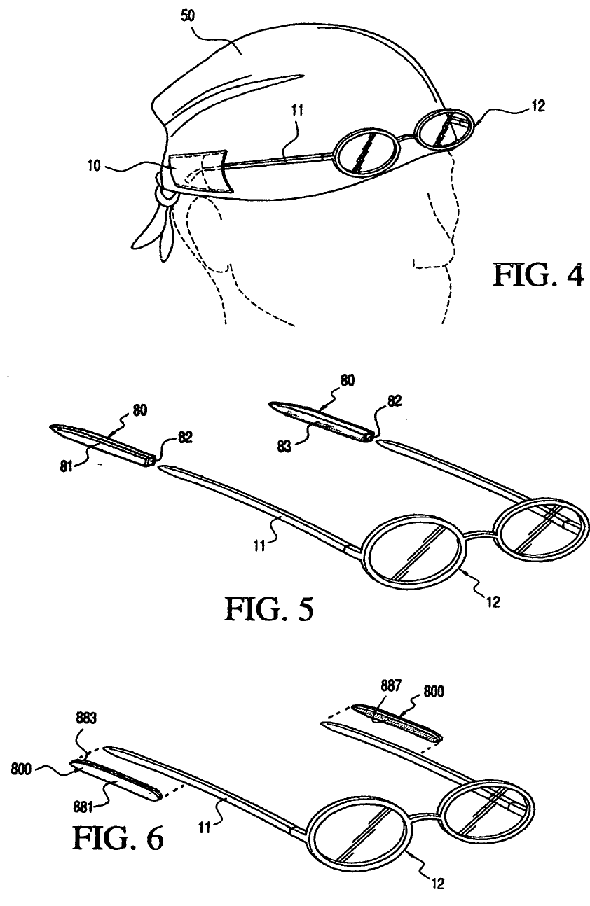

FIG. 4 shows the device 10 in use on an alternate form of headwear 50, wherein the headwear 50 is a bandanna It should be appreciated that in other various exemplary embodiments, other forms of headwear may be used such as, but not limited to ski caps, cowboy hats, or any active headwear for example.

FIG. 5 shows another exemplary embodiment of the device 10, wherein device 10 further includes a second member 80. The device 10 in FIG. 5 includes all the characteristics as the device 10 in FIGS. 1 through 3. The second member 80 is an attachment to the present invention for placing on the temples 11 of eyewear 12, wherein the temple 11 of the eyewear 12 is of a non-metallic material. In the embodiment shown in FIG. 5, the second member 80 is a cover, such that second member 80 is operably configured to receive the temple 11.

The second member 80 includes a first material 81 and second material 83. It is preferred that the first material 81 be ferrous and that the second material 83 be stretchable. The second material 83 of the second member 80 is constructed such that is forms a flexible tube with at least one open end 82. The open end 82 is operably configured to receive the temple 11. The open end 82 is generally of a smaller size than the size of the temple 11. The temple 11 is inserted into the open end 82. The second member 80 then stretches open to receive the temple 11 and closes tightly around the temple 11 to remain in place. It should be appreciated that in other various exemplary embodiments the cover could be held in place on the temple by other methods such as, but not limited to, an adhesive inside the second member or other means common in the art. The second material 83 is made from material such as, but not limited to, rubber, neoprene or other stretchable material common in the art. The first material 81 is sewn on or into the fabric of the second material 83. Further, the first and second material 81 and 83 could be integral to each other. It should be appreciated that in other various exemplary embodiments, the second material 83 could be of a non-stretchable material and attach to the temples by other means, such as, but not limited to, a sock-shape material with tie strings, for example.

The first material 81 in this embodiment is a material with magnetic properties that allows the first material 81 to be attracted to the retaining member 45. It should be appreciated that in other various exemplary embodiments, the first material could be made of other materials such as but not limited to hook and loop fasteners, for example to allow the first material to be retained by the device 10.

The preferred embodiment has one second member 80 on each of the temples 11 of the eyewear 12 as shown in FIG. 5. It should be appreciated that in other various embodiments, only one second member could be placed on only one of the temples of the eyewear. Further, it is contemplated in this invention that the second member 80 could be placed on other objects such as, but not limited to, pencils, artist paint brushes, thin flashlights, etc., anything that is made of a ferrous material and the user desires to hold in place on the headwear 50.

With the second member 80 on the temple 11, the eyewear 12 is held in place by the retaining member 45 in the pocket 35 attracting the first material 81 in the second member 80. When the user places the eyewear 12 fitted with the second members 80 on each temple 11 on the headwear 50, the first material 81 of the second members 80 are retained by the retaining member 45 in the pocket 35 and retains the eyewear 12 in place on the headwear 50.

FIG. 6 shows an alternative exemplary embodiment of second member 800, wherein second member 800 includes the characteristics of the second member 80, in that second member 800 includes first material 881 and second material 883. Second member 800 differs from second member 80 in that second material 883 is not tubular and does not have an open end.

The first material 881 comprises a material that is ferrous to allow it to be retained magnetic member within the device 10.

The second material 883 is the base material that first material 881 is attached to. First material 881 in the preferred embodiment is glued to second material 883. It should be appreciated that in other various exemplary embodiments, the first material could be sewn into the second material or be integral to the second material.

The second material 883 has a generally elongated oval shape to match the shapes of the temple 11 of eyewear 12. The second material 883 is flexible to allow the second material 883 to mold to the contour of the temple 11. It should be appreciated that in other various exemplary embodiments, other shapes such as elongated rectangle could be used or whatever shape that is necessary to match the temple being used.

Additionally, as shown in FIG. 6, the second material 883 includes an adhesive backing, 887. The adhesive backing 887 is disposed on the second material 883 on the side opposite of the first material 881. Further, the adhesive backing 887 includes a protective strip, (not shown), which is removed by the user when the second member 800 is ready for applying to the temple 11.

The second member 800 is placed on the temple 11 by the user removing the protective cover and attaching the second member 800 to the temple 11, such that the second member 800 is on the part of the temple 11 that is disposed towards the user's head.

With the second member 800 on the temple 11, the eyewear 12 is held in place by the retaining member 45 in the pocket 35 attracting the ferrous material in the first material 881. When the user places the eyewear 12 fitted with the second member 800 on each temple 11 on the headwear 50, the second members 800 are retained in the device 10 by the retaining member 45 in the pocket 35 and holds the eyewear 12 in place on the headwear 50.

Additionally, it is contemplated by the present invention that the device 10 may be used on other articles of clothing or items worn by the user. For example, the device 10 may be sewn into a shirt pocket, the second member 80 installed on the temples 11 of the eyewear 12 and the temple inserted in the channel 47 to retained the eyewear 12 to the pocket. This would prevent the eyewear 12 from falling out of the user's pocket when the user leans over. Another example is for the device 10 to be disposed to the shoulder strap of a backpack, such that when the user wears a backpack the device 10 is easily accessible to the user on the shoulder strap on the chest of the user. The device 10 used in this manner is readily available to the user to store and retain any eyewear 12.

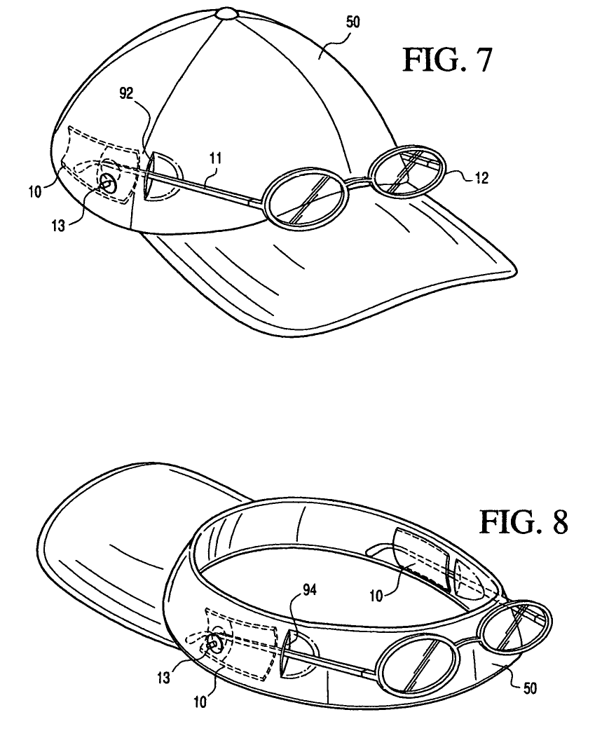

FIG. 7 is an alternate exemplary embodiment of the device 10, wherein the device 10 is disposed on an interior of the sides 55 and 56 of the headwear 50. The headwear 50 further includes a first opening or slit 92. The first opening 92 is a hemmed vertical cut in the material of the headwear 50 disposed on the sides 55 and 56, such that the first opening 92 is substantially coaxially aligned with the first opening 48 of the device 10. The user inserts the temples 11 through the first opening 92 and into the channel 47 of the device 10.

FIG. 8 is another exemplary embodiment of the device 10, wherein the device 10 is disposed on the interior of the sides 55 and 56 of the headwear 50. The headwear 50 further includes a second opening or slit 94. The second opening 94 is a hemmed vertical cut in the material of the headwear 50 dispose on the sides 55 and 56, such that the second opening 94 is coaxially aligns with the second opening 49 of the device 10. The user inserts the temples 11 through the first opening 92 and into the channel 47 of the device 10. Additionally, the headgear 50 in FIG. 8 is an example of the device 10 installed on a sun visor. It should be appreciated that in other various exemplary embodiments, the slits could be disposed such that the slits are on the front and the back

FIG. 9 is an example of an exemplary embodiment, wherein the device 10 is retaining objects other than eyewear. In FIG. 9, a flashlight and a pencil are inserted into and retained by the device 10. For example, for an aluminum flashlight a second member as described above, not shown, would be attached to the flashlight and inserted into the device 10; whereas a pencil, which has a metallic end, would be directly inserted into device 10, so as to be retained by the magnetic member therein.

FIG. 10 is still further another exemplary embodiment of the device 10, wherein the device 10 includes a fastener 93 disposed on the first side portion 30 of member 20, wherein the fastener 93 is a hook and loop type fastener and is operably configured to receive other objects 98, such as a patch. The patch 98 has indicia thereon such as logos or trademarks. It is conceived that the patch 98 is easily removable such that the user could readily change the patch to display patches with other logos or trademarks. It should be appreciated that in other exemplary embodiments, the patch could be ferrous and therefore be retained to the device by the magnetic member within the device. Further, it should be appreciated that in other various exemplary embodiments, the fastener could be of other types of fastener common in the art such as, but not limited to, snaps, buttons, etc. In this embodiment the other object 98 is a logo patch operably configured to attach to fastener 93. It should be appreciated that in other various exemplary embodiments, the other objects could be other items as desired by the user.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A headwear object retaining system for securing an object, which includes a ferrous portion, comprising:
a headwear;
a member having a cavity and being disposed on the headwear such that a channel is formed between the member and the headwear, wherein the channel has an opening and the channel is operably configured to receive the ferrous portion of the object through the opening; and,
a magnetic member being disposed within the cavity and operably configured to magnetically engage the ferrous portion of the object.

2. A headwear object retaining system, as recited in claim 1, wherein, the magnetic member is operably configured to retain the object to the headwear.

3. A headwear object retaining system, as recited in claim 1, wherein, the headwear includes opposing side portions and a front portion, the member is disposed on one of the side portions, and the opening is disposed generally towards the front of the headwear.

4. A headwear object retaining system, as recited in claim 1, wherein, the headwear includes a back portion and the channel includes a second opening, wherein the second opening is disposed generally towards the back portion and the channel is configured to receive the ferrous portion of the object through the second opening.

5. A headwear object retaining system, as recited in claim 1, wherein the object is eyewear.

6. A headwear object retaining system, as recited in claim 1, wherein, the headwear further includes an interior and exterior surface and a slit extending between the interior and exterior surfaces, the member is disposed on the interior surface and the opening is aligned with the slit.

7. A headwear object retaining system, as recited in claim 1, wherein the magnetic member is a strip of magnetic material having a length that substantial equal to a length of the cavity.

8 A headwear object retaining system, as recited in claim 1, wherein a second object having ferrous portions is removably held adjacent to an exterior surface of the first member by the magnetic member.

9. A headwear object retaining system, as recited in claim 1, wherein the magnetic member is a neodymium magnetic wafer.

10. A headwear object retaining system, as recited in claim 1, wherein the headwear is a baseball hat.

11. A headwear object retaining system, as recited in claim 1 further comprising a second member having a ferrous portion, the second member is operably configured to be removably attached to the object and is operably configured to be the ferrous portion of the object.

12. A headwear object retaining system, as recited in claim 1, further comprising a patch having a ferrous portion removably attached to an exterior surface of the member.

13. A headwear object retaining system, as recited in claim 12, wherein the patch is removably attached to the member by the magnetic member.

14. A headwear object retaining system, as recited in claim 12, wherein the patch is removably attached to the member by hook and loop fasteners.

15. A retention device for securing an object, which includes a ferrous portion, to a headwear comprising:
a first member having a cavity and being disposed on the headwear such that a channel is formed between the first member and the headwear, wherein the channel has an opening and the channel is operably configured to receive the ferrous portion of the object through the opening; and,
a magnetic member being disposed within the cavity and operably configured to magnetically engage the ferrous portion of the object.

16. A retention device, as recited in claim 15, wherein the object is eyewear having two temples.

17. A retention device, as recited in claim 16, further comprising a second first member, wherein one of the first members is disposed on one of a side of the headwear and the other of the first members is disposed on an opposing side of the headwear and the first members are operably configured to engage the temples.

18. A retention device, as recited in claim 15, further comprising a second member having a ferrous portion, the second member is operably configured to be removably attached to the object and is operably configured to be the ferrous portion of the object.

19. A retention device for securing an object to a headwear comprising:
a first member having a cavity and being disposed on the headwear such that a channel is formed between the first member and the headwear, wherein the channel has an opening and the channel is operably configured to receive the ferrous portion of the object through the opening;
a second member having a ferrous portion wherein the second member is removably attached to the object; and,
a magnetic member being disposed within the cavity and operably configured to magnetically engage the ferrous portion of the second member.

20. A retention device, as recited in claim 19, wherein the object is eyewear having two temples.

21. A retention device, as recited in claim 20, further comprising a second first member, wherein one of the first members is disposed on one of a side of the headwear and the other of the first members is disposed on an opposing side of the headwear and the first members are operably configured to engage the temples.

22. A retention device, as recited in claim 19, wherein the object is a flashlight.

23. A retention device for securing an object, which includes a ferrous portion, to an article of clothing comprising:
a member having a cavity and being disposed on the article of clothing such that a channel is formed between the member and the article of clothing, wherein the channel has an opening and the channel is operably configured to receive the ferrous portion of the object through the opening; and,
a magnetic member being disposed within the cavity and operably configured to magnetically engage the ferrous portion of the object.

24. A retention device, as recited in claim 23, wherein article of clothing is a bandana.

25. A retention device, as recited in claim 23, wherein the object is eyewear.

26. A retention device, as recited in claim 23, further comprising a second member having a ferrous portion, the second member is operably configured to be removably attached to the object and is operably configured to be the ferrous portion of the object.

27. A headwear eyewear retaining system for securing eyewear having two temples with ferrous portions comprising:
a headwear having two opposing side portions, and front and back portions;
two first members each having a cavity and one of the members being disposed on one of the side portions of the headwear and the other of the first members being disposed on the opposing side portion of the headwear, each of the first members being disposed on the headwear such that a channel is formed between each of the first members and the headwear, wherein each of the channels has an opening and each of the channels is operably configured to receive a portion of one of the temples of the eyewear through the opening; and,
a magnetic member being disposed within each of the cavities of the first members and operably configured to magnetically engage the ferrous portions of the temples.

28. A headwear eyewear retaining system, as recited in claim 27, wherein, the magnetic member is operably configured to retain the eyewear to the headwear.

29. A headwear eyewear retaining system, as recited in claim 27, wherein, each of the channels includes a second opening, wherein each of the second openings is disposed generally towards the back portion and each of the channels is configured to receive the ferrous portions of the temples through the second openings.

30. A headwear eyewear retaining system, as recited in claim 27, wherein, the headwear further includes two slits on opposing sides of the headwear extending between the interior and exterior surfaces, each of the first members is disposed on the interior surface and the opening of the first first member is aligned with one slit and the opening of the second first member is aligned with the opposing slit.

31. A headwear eyewear retaining system, as recited in claim 27, wherein a second object having ferrous portions is removably held adjacent to an exterior surface of the first member by the magnetic member.

32. A headwear eyewear retaining system, as recited in claim 27, wherein each of the magnetic members is a neodymium magnetic wafer.

33. A headwear eyewear retaining system, as recited in claim 27, wherein the headwear is a baseball hat.
